(19) United States
(12) Patent Application Publication
(10) Pub. No.: US 2024/0246627 A1
(43) Pub. Date: Jul. 25, 2024

(54) FAIRING ASSEMBLY

(71) Applicant: Harley-Davidson Motor Company, Inc., Milwaukee, WI (US)

(72) Inventors: Jordan Odehnal, Menomonee Falls, WI (US); Bryan Books, Thiensville, WI (US); Paul Thomas, Waukesha, WI (US)

(73) Assignee: Harley-Davidson Motor Company, Inc., Milwaukee, WI (US)

(21) Appl. No.: 18/158,611

(22) Filed: Jan. 24, 2023

(51) Int. Cl. B62J 9/12; B62J 17/02

(52) U.S. Cl. CPC B62J 9/12; B62J 17/02

(57) ABSTRACT

A fairing assembly that includes a fairing body and a storage compartment attached to the fairing body. The storage compartment includes a frame housing that serves as a load-bearing structural member of the fairing body. The frame housing includes an upper frame housing member and a lower frame housing member that collectively define an interior space that receives a retractable drawer mounted therein. The retractable drawer is selectively moveable in a longitudinal direction relative to the frame housing between a closed position and an open position.

### TECHNICAL FIELD

One or more embodiments relate generally to a fairing assembly, and a vehicle having such a fairing assembly. The fairing assembly includes a storage compartment having a frame housing that serves as a load-bearing structural member of the fairing assembly.

### BACKGROUND

Existing motorcycle fairing assemblies lack one or more storage compartments having a structural configuration that is structurally integrated as a load-bearing member of the fairing body.

### BRIEF SUMMARY

In accordance with one or more embodiments, an example fairing assembly is provided that comprises a storage compartment having a structural configuration that is structurally integrated as a load-bearing member of the fairing body.

In accordance with one or more embodiments, an example fairing assembly comprises one or more of the following: a fairing body and a storage compartment attached to the fairing body, the storage compartment including a frame housing serving as a load-bearing structural member of the fairing body, the frame housing including an upper frame housing member and a lower frame housing member that collectively define an interior space; and a retractable drawer defining a storage space sized to receive one or more items therein, the retractable drawer being mounted in the interior space for movement in a longitudinal direction relative to the frame housing between a closed position and an open position.

In accordance with one or more embodiments, another example fairing assembly comprises one or more of the following: a fairing body and a storage compartment attached to the fairing body, the storage compartment including a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body; and a retractable drawer defining a storage space sized to receive one or more items therein, the retractable drawer being mounted in the interior space for movement in a longitudinal direction relative to the frame housing between a closed position and an open position.

In accordance with the example fairing assembly, the retractable drawer comprises sidewalls having a gear track extending in a longitudinal direction along an outer surface thereof to facilitate movement of the retractable drawer between the closed position and the open position.

In accordance with the example fairing assembly, one or more rotational gear dampers are mounted on an inner surface of sidewalls of the upper frame housing member, and operatively connected to the gear track for rotation to provide resistance against the movement of the retractable drawer member between the closed position and the open position.

In accordance with the example fairing assembly, a latch member is attached to the retractable drawer and moveable by engagement of a user between a latched position to initiate movement of the retractable drawer from the closed position to the open position.

In accordance with the example fairing assembly, one or more bumper members are mounted on a rear wall of the retractable drawer, and operable to engage a rear wall of the upper frame housing member when the retractable drawer is advanced to the closed position.

In accordance with the example fairing assembly, one or more bias members, connected at one end to the retractable and an opposite end to the lower frame housing member, are operable to advance the retractable drawer between the closed position and the open position.

In accordance with one or more embodiments, a motorcycle comprises one or more of the following: a vehicle structure; and a fairing assembly connected to the vehicle structure, the fairing assembly including: a fairing body; and a storage compartment structurally integrated with the fairing body, the storage compartment including a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body, and a retractable drawer defining a storage space sized to receive one or more items therein, the retractable drawer being mounted in the interior space for movement in a longitudinal direction relative to the frame housing between a closed position and an open position.

In accordance with the example motorcycle, the retractable drawer comprises sidewalls having a gear track extending in a longitudinal direction along an outer surface thereof to facilitate movement of the retractable drawer between the closed position and the open position.

In accordance with the example motorcycle, one or more rotational gear dampers are mounted on an inner surface of sidewalls of the upper frame housing member, and operatively connected to the gear track for rotation to provide resistance against the movement of the retractable drawer member between the closed position and the open position.

In accordance with the example motorcycle, a latch member is attached to the retractable drawer and moveable by engagement of a user between a latched position to initiate movement of the retractable drawer from the closed position to the open position.

In accordance with the example motorcycle, one or more bumper members are mounted on a rear wall of the retractable drawer, and operable to engage a rear wall of the upper frame housing member when the retractable drawer is advanced to the closed position.

In accordance with the example motorcycle, a rear wall of the retractable drawer comprises a through hole to receive a charging cable to facilitate recharging of a rechargeable power source of an electronic device received in the storage space.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 illustrates an example vehicle, in accordance with one or more embodiments set forth, shown, and described herein.

FIG. 2 illustrates an example fairing assembly for a vehicle, in accordance with one or more embodiments set forth, shown, and described herein.

FIG. 3 illustrates an exploded perspective view of a retractable drawer for a storage compartment of the fairing assembly of FIG. 2.

FIG. 4 illustrates a side, exploded view of the retractable drawer of FIG. 3.

FIG. 5 illustrates a top, exploded view of the retractable drawer of FIG. 3.

FIG. 6 illustrates a bottom, exploded view of the retractable drawer of FIG. 3.

FIG. 7 illustrates a perspective view of a storage compartment of the fairing assembly of FIG. 2.

FIG. 8 illustrates a perspective exploded view of the storage compartment of FIG. 7.

FIG. 9 illustrates a front view of the storage compartment of FIG. 7.

FIG. 10 illustrates a side view of the storage compartment of FIG. 7.

FIG. 11 illustrates a side view of the storage compartment of FIG. 7.

FIG. 12 illustrates a bottom view of the storage compartment of FIG. 7.

FIG. 13 illustrates a top, sectional view of the storage compartment of FIG. 7.

FIG. 14 illustrates a partial rear view of a retractable drawer of the storage compartment of FIG. 7.

FIG. 15 illustrates a partial front view of a retractable drawer of the storage compartment of FIG. 7.

FIG. 16 illustrates a perspective view of a storage compartment of the fairing assembly of FIG. 2.

FIG. 17 illustrates a side view of a storage compartment of the fairing assembly of FIG. 2.

### DETAILED DESCRIPTION

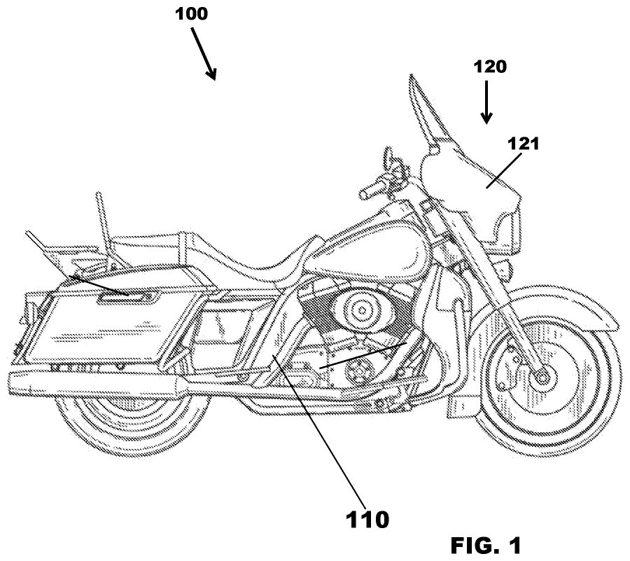

Turning to the figures, in which FIG. 1 illustrates an example vehicle 100, in accordance with one or more embodiments set forth, shown, and described herein. In the illustrated examples, the vehicle 100 comprises a two-wheeled vehicle such as, for example a motorcycle. Embodiments, however, are not limited thereto, and thus, this disclosure contemplates the vehicle comprising any suitable vehicle that falls within the spirit and scope of the principles of this disclosure.

As illustrated in FIG. 1, the vehicle 100 comprises a structure 110 (e.g., a chassis, frame, subframe, body, etc.) and a fairing assembly 120 mounted on the structure 110. The fairing assembly 120 comprises a fairing body 121 mounted on the vehicle structure 110 and a storage compartment assembly 130 structurally integrated with the fairing body 121.

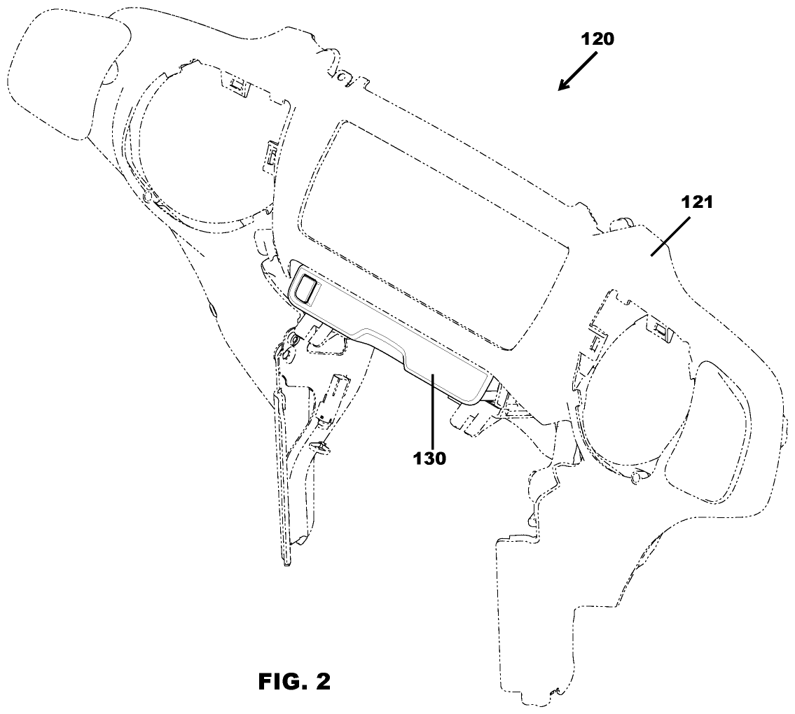

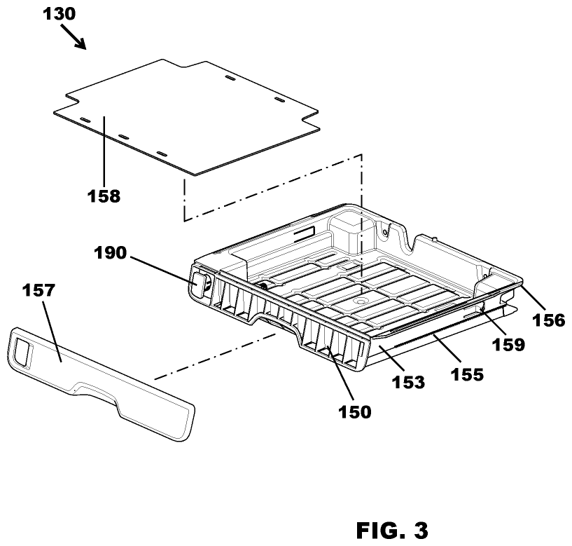

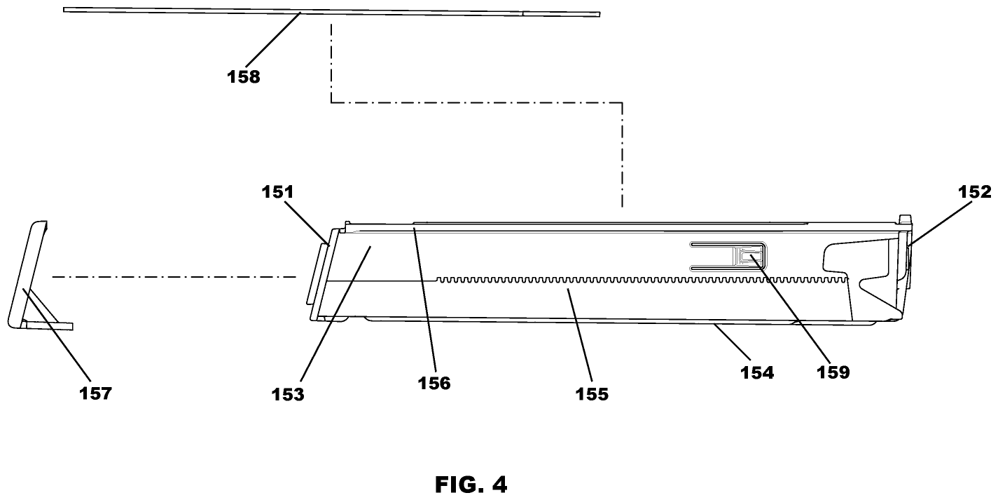

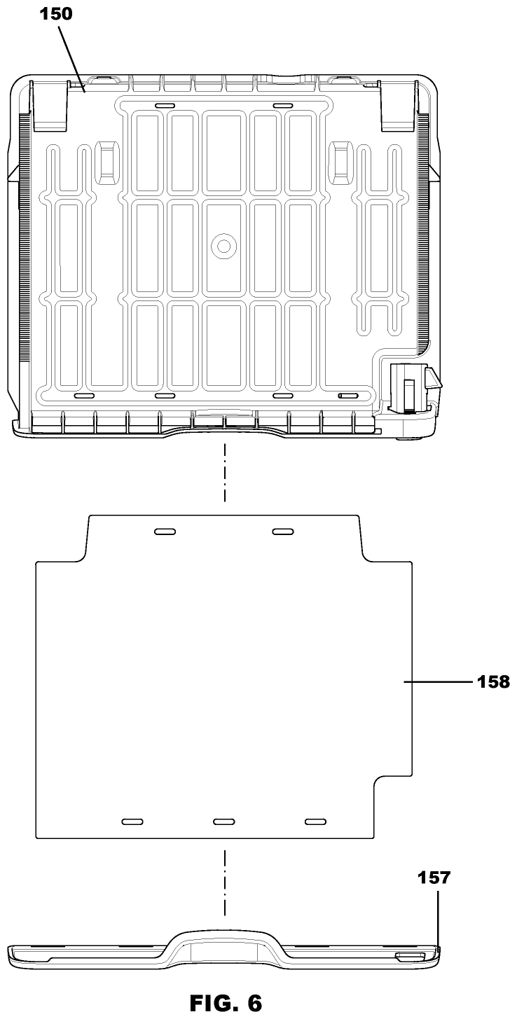

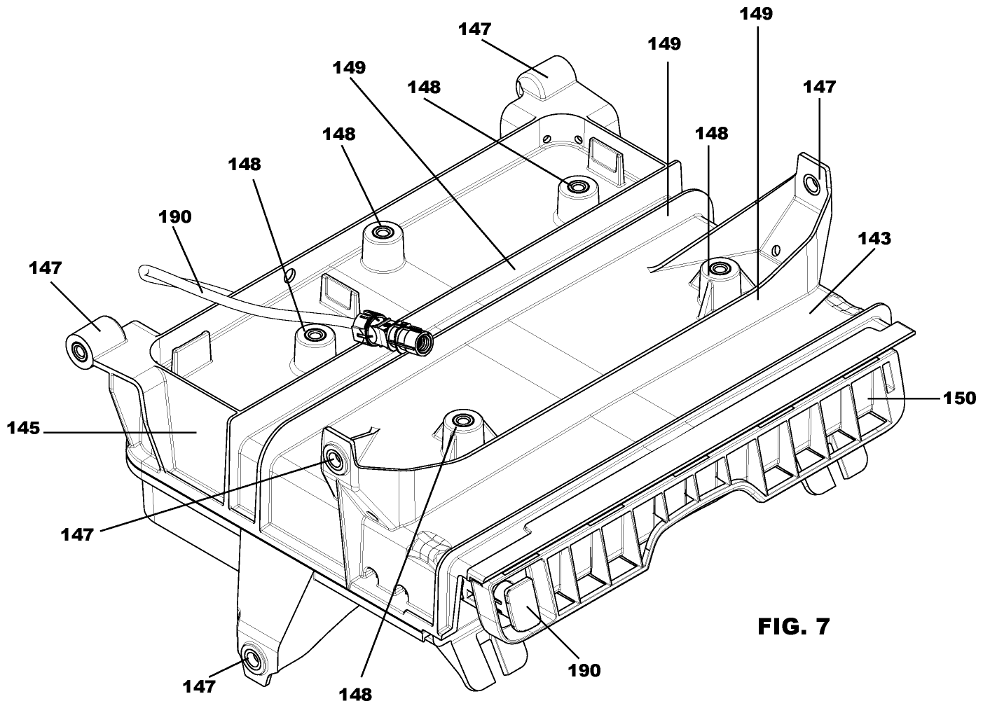

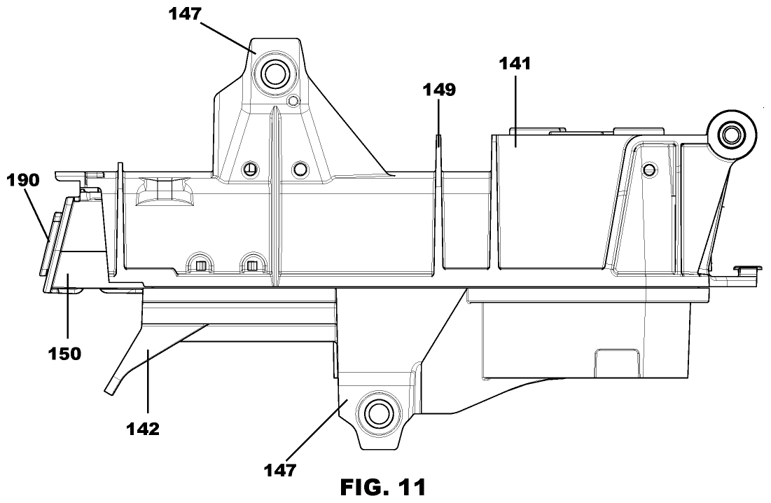

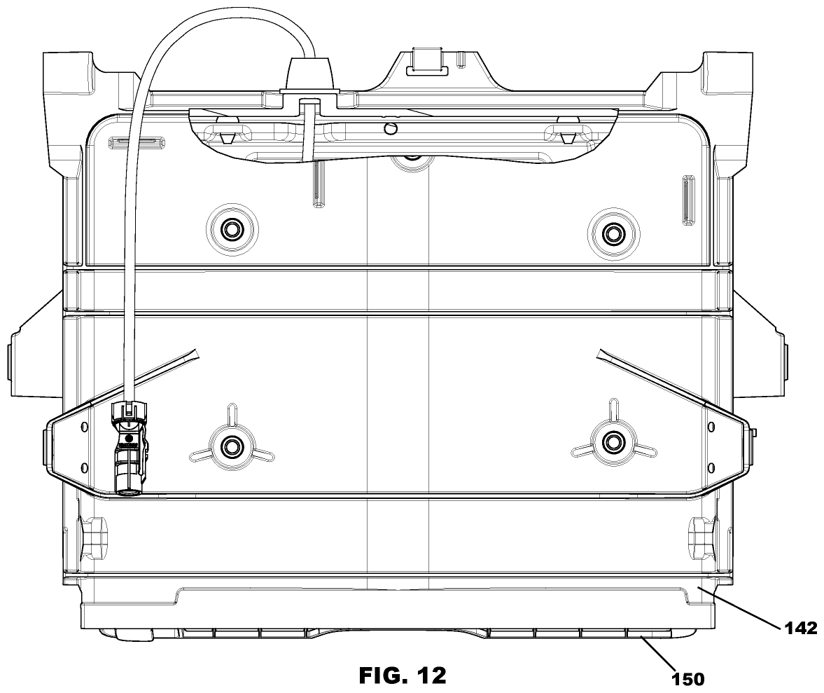

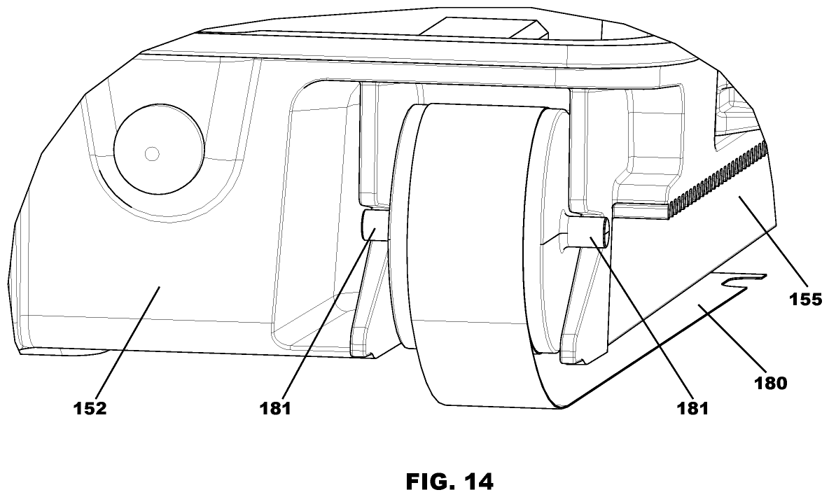

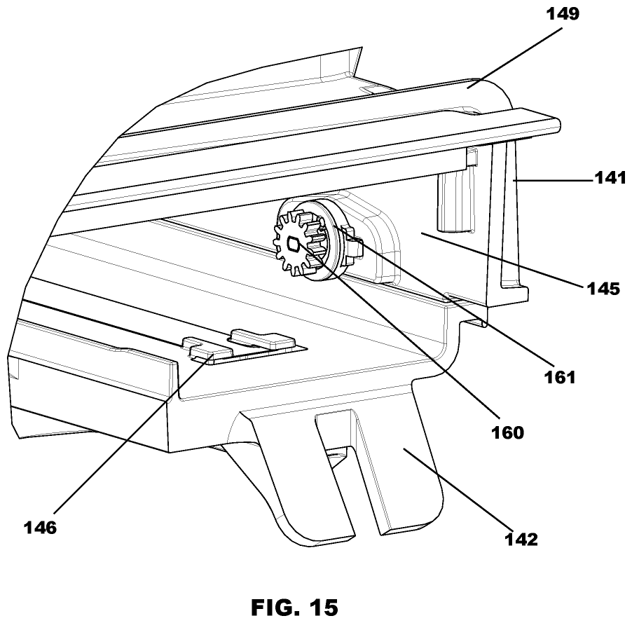

In accordance with one or more embodiments set forth, shown, and described herein, the storage compartment assembly 130 may not include one or more of the structural elements illustrated in FIGS. 2 through 16. The storage compartment assembly 130 may, in accordance with one or more embodiments set forth, shown, and described herein, have additional elements to those illustrated in FIGS. 2 through 16. In accordance with one or more embodiments set forth, shown, and described herein, the fairing assembly 120 (and relevant components thereof) is composed in whole or in part of a polymer material. Embodiments, however, are not limited thereto. This disclosure contemplates the fairing assembly 120 being composed of any suitable material that falls within the spirit and scope of the principles of this disclosure.

As illustrated in FIGS. 1 and 2, the fairing assembly 120 comprises a fairing body 121 mounted on the vehicle structure 110 and a storage compartment 130 structurally integrated with the fairing body 121.

### Frame Housing

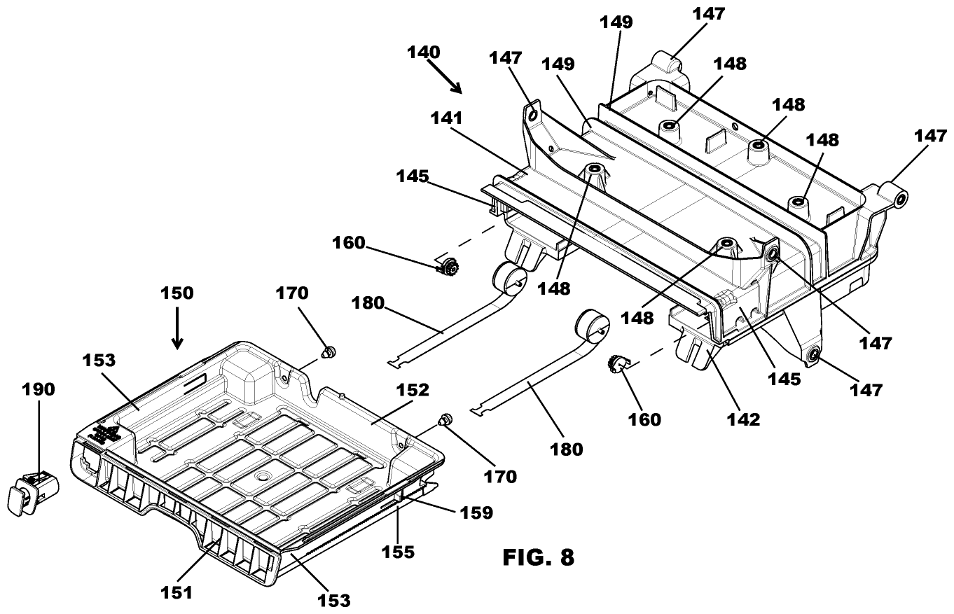

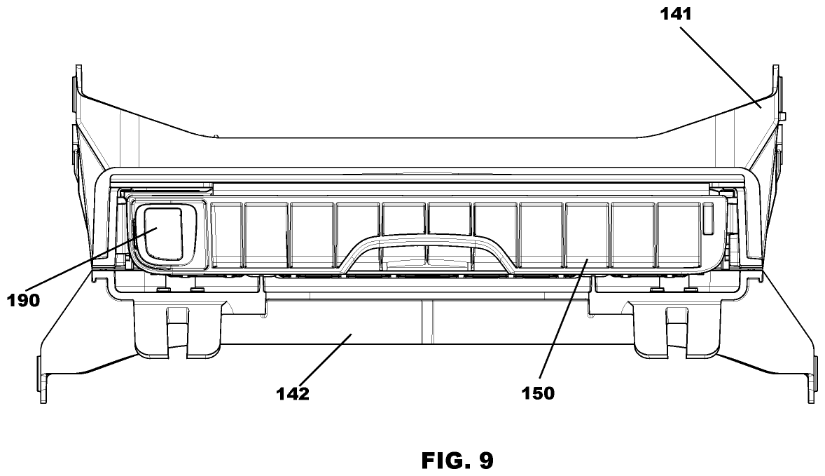

As illustrated in FIGS. 8 and 9, the storage compartment 130 comprises a frame housing 140 serving as a load-bearing structural member of and connected to the fairing body 120. The frame housing 140 comprises a bifurcated structural configuration that includes an upper frame housing member 141 and a lower frame housing member 142 forming an interconnection that defines an interior space to receive a retractable drawer 150. In accordance with one or more embodiments set forth, shown, and described herein, the upper frame housing member 141 and the lower frame housing member 142 are connected together via a vibration welding technique. Embodiments, however, are not limited thereto. This disclosure contemplates connecting the upper frame housing member 141 and the lower frame housing member 142 using any suitable technique that falls within the spirit and scope of the principles of this disclosure. For example, the upper frame housing member 141 and the lower frame housing member 142 may be integrally formed, using a molding technique, as a single, unitary body.

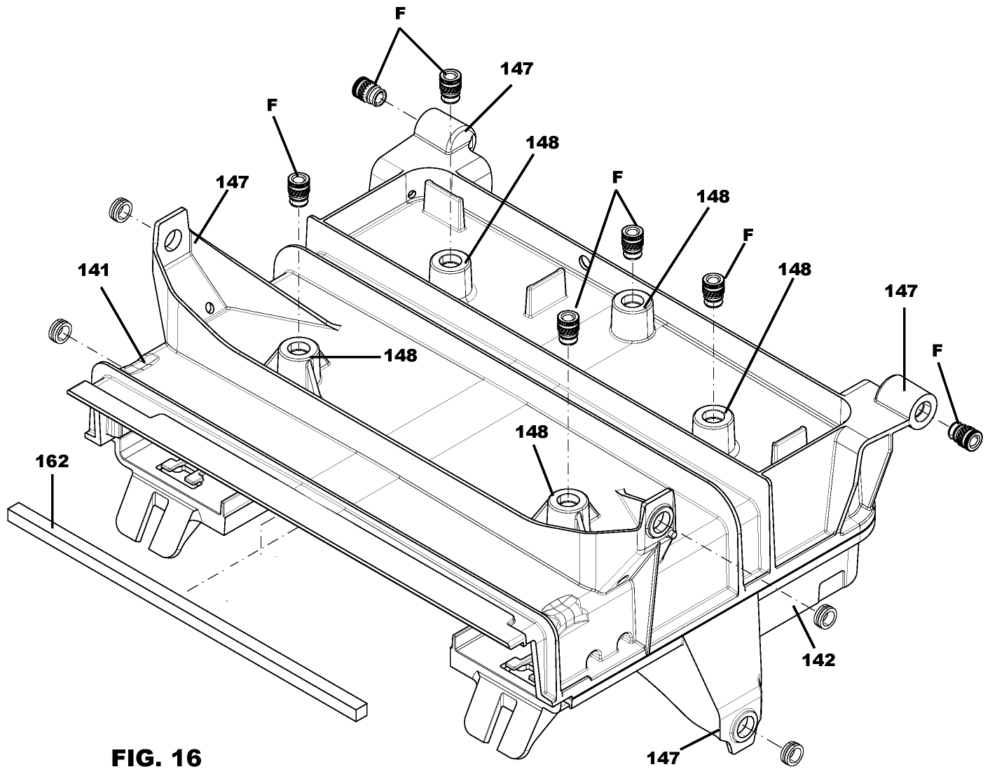

In the illustrated embodiment, the upper frame housing member 141 comprises a top wall 143, a rear wall 144, and a pair of opposing sidewalls 145 extending between the top wall 143 and the rear wall 144. As illustrated in FIG. 16, one or more rotational gear dampers 160 are mounted on a carrier 161 on an inner surface of the sidewalls 145 at a forward region of the upper frame housing member 141.

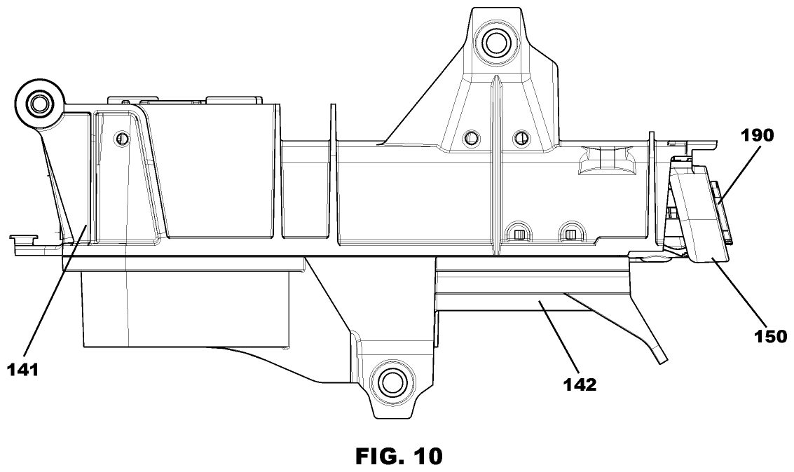

As illustrated in FIGS. 10, 11, and 16, the upper frame housing member 141 and the lower frame housing member 142 have a plurality of connection regions to which are arranged compression limiters 147 and threaded inserts 148 which facilitate connection of the storage compartment 130 to the fairing body 121 via threaded mechanical fasteners F such as, for example, screws or bolts. In order to provide a robust structural configuration of the fairing assembly 120, the upper wall 143 of the upper frame housing member 141 includes one or more load-bearing exterior structural rib members 149 extending in a transverse direction to bear loads applied to the fairing body 121. In accordance with one or more embodiments set forth, shown, and described herein, the frame housing 140 is composed in whole or in part of a polymer material. Embodiments, however, are not limited thereto. This disclosure contemplates the frame housing 140 being composed of any suitable material that falls within the spirit and scope of the principles of this disclosure.

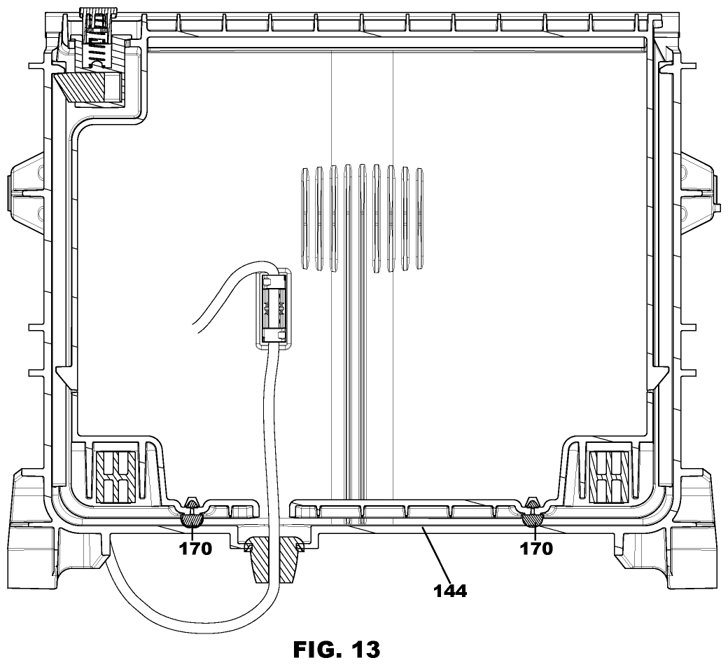

As illustrated in FIG. 13, the rear wall 144 of the upper frame housing member 141 includes an opening or through hole operable to receive a data and/or power line such as, for example, a USB-C charging cable to facilitate recharging of a rechargeable power source of an electronic device received in a storage space of the retractable drawer 150. The USB-C charging cable may be attached to the retractable drawer 150 via a grommet member that is operable for receipt in the through hole.

### Retractable Drawer

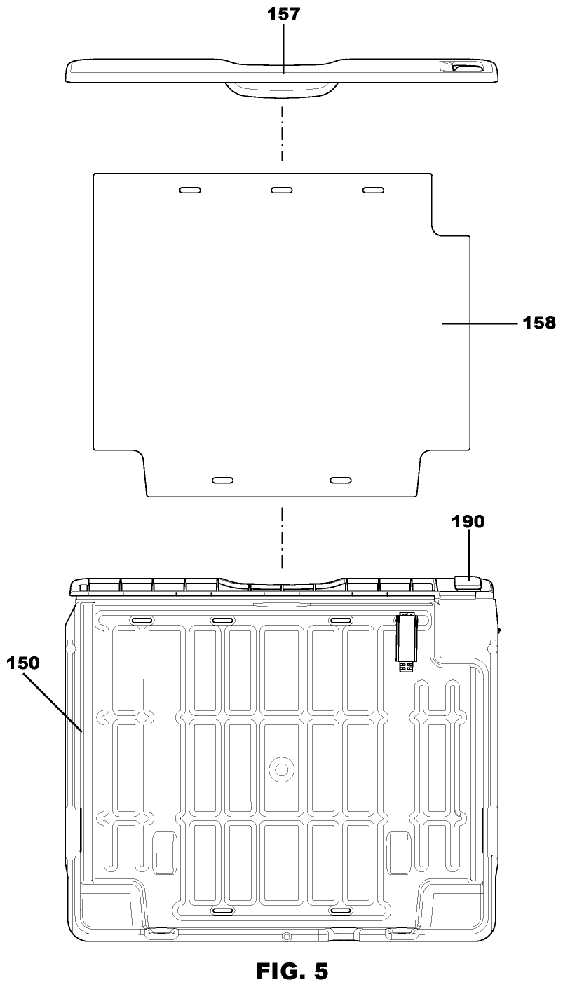

As illustrated in FIGS. 5 through 12, the retractable drawer 150 is moveably mounted in the interior space of the frame housing 140 for movement in a longitudinal direction between a closed position and an open position. The retractable drawer 150 has a generally rectangular structural configuration that includes a front wall 151, a rear wall 152, a pair of opposing sidewalls 153, and a bottom wall 154 defining a storage space to receive one or more items or articles therein including, but not limited to a USB-C cable (See, FIG. 5). A drawer liner member 158 is removably received in the storage space for placement on the interior surface of the bottom wall 154 to limit the amount of movement of the items or articles inside the retractable drawer 150. The drawer liner member 158 has a support surface that is composed of an anti-slip material having a coefficient of friction that inhibits movement of items or articles thereon. In this way, the items or articles are anchored or otherwise maintained on the support surface.

A pin/boss member 159 is arranged on both outer sidewalls 153 of the retractable drawer 150 are operable to restrict travel of the retractable drawer 150 as it advances to the open position. In essence, each pin/boss member 159 prevents the retractable drawer 150 from sliding too far outwardly relative to the frame housing 140. The pin/boss member 159 are compressible for movement that facilitates removal of the retractable drawer 150 from the frame housing 140.

The exterior surface of each sidewall 153 comprises a gear track 155 that extends in a longitudinal direction, and is operatively connected to the one or more rotational gear dampers 160. The one or more rotational gear dampers 160 are rotationally moveable on each gear track 155 to provide resistance against the movement of the retractable drawer member 150 between the closed position and the open position. An upper sliding rib member 156 extends in a perpendicular direction relative to a corresponding sidewall 153 to facilitate movement of the retractable drawer 150 along the frame housing 140 between the closed position and the open position.

A latch member 190 is attached to an exterior surface of the front wall 151 of the retractable drawer 150. The latch member 190 is moveable by engaged contact of a user between a latched position which initiates movement of the retractable drawer 150 to the closed position, and an unlatched position to initiate movement of the retractable drawer 150 to the open position. The movement of the retractable drawer 150 is damped by action of the rotational gear dampers 160.

A front press cover member 157 is mounted on the exterior surface of the front wall 151 of the retractable drawer 150. The front press cover member 157 has an opening through which the latch member 190 protrudes. A user may thereby engage the latch member 190 to cause the retractable drawer 150 to advance to the open position.

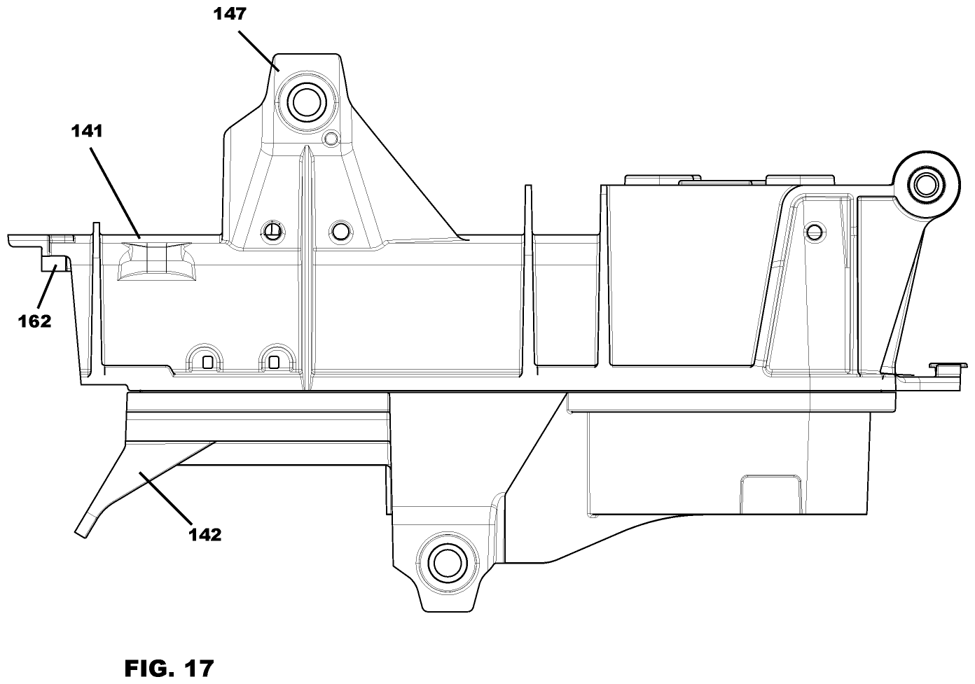

As illustrated in FIGS. 16 and 17, a seal member 162, attached to a rib of the upper frame housing member 141, is provided to provide resistance to water entering into the interior space of the frame housing 140 in instances when the retractable drawer 150 reaches its closed position. When the retractable drawer 150 reaches its closed position, the seal member 162 is compressed by the front vertical wall of the retractable drawer 150 and the rib of the upper frame housing member 141. The seal member 162 comprises a foam gasket that provides the necessary water resistance.

One or more bumper members 170 are mounted via holes or openings on the rear wall 152 of the retractable drawer 150. In an embodiment having two or more bumper members 170, the bumper members 170 are mounted spaced apart on the rear wall 152. The one or more bumper members 170 have an abutment or contact surface which is operable to engage or otherwise contact the rear wall 144 of the upper frame housing member 141 when the retractable drawer 150 is fully seated in the closed position. The one or more bumper members 170 is composed in whole or in part of an elastic material. Such a material may comprise rubber. Embodiments, however, are not limited thereto, and thus, this disclosure contemplates the one or more bumper members 170 being composed of any suitable material that falls within the spirit and scope of the principles of this disclosure.

### Bias Members

One or more bias members are provided to cause movement of the retractable drawer 150 between the closed position and the open position. The one or more bias members comprise an elongated, flat spiral spring member 180 wound about a rotary shaft 181 operable to rotate about an axis of rotation. A first end of each elongated, flat spiral spring member 180 is connected to or otherwise retained by a corresponding boss member 146 located at an interior surface of a bottom wall of the lower frame housing member 142. The rotary shaft 181 is mounted on a rear exterior surface of the rear wall 152 of the retractable drawer 150.

In operation, a user may engage the latch member 190 to selectively move the retractable drawer 150 from the closed position to the open position. Each elongated, flat spiral spring member 180, in response to such user engagement, is operable to apply a bias force on the retractable drawer 150 which advances the retractable drawer 150 forwardly in the longitudinal opening direction to the open position against the damping force of the rotational gear dampers 160.

A user may engage the retractable drawer 150 to selectively retract the retractable drawer 150 from the open position to the closed position. Each elongated, flat spiral spring member 180 is operable, in response to such user engagement, to apply a bias force on the retractable drawer 150 which retracts the rearwardly in a longitudinal closing direction to the closed position against the damping force of the rotational gear dampers 160.

### Examples

The disclosure further includes additional notes and examples, as set forth in the following clauses.

Clause 1A. A fairing assembly, comprising: a fairing body; and a storage compartment attached to the fairing body, the storage compartment including: a frame housing serving as a load-bearing structural member of the fairing body, the frame housing including an upper frame housing member and a lower frame housing member that collectively define an interior space; and a retractable drawer defining a storage space sized to receive one or more items therein, the retractable drawer being mounted in the interior space for movement in a longitudinal direction relative to the frame housing between a closed position and an open position.

Clause 2A. The fairing assembly of Clause 1A, wherein the retractable drawer comprises sidewalls having a gear track extending in a longitudinal direction along an outer surface thereof to facilitate movement of the retractable drawer between the closed position and the open position.

Clause 3A. The fairing assembly of Clause 2A, further comprising one or more rotational gear dampers, mounted on an inner surface of sidewalls of the upper frame housing member, and operatively connected to the gear track for rotation to provide resistance against the movement of the retractable drawer member between the closed position and the open position.

Clause 4A. The fairing assembly of Clause 1A, further comprising a latch member attached to the retractable drawer and moveable by engagement of a user between a latched position to initiate movement of the retractable drawer from the closed position to the open position.

Clause 5A. The fairing assembly of Clause 1A, further comprising one or more bumper members, mounted on a rear wall of the retractable drawer, and operable to engage a rear wall of the upper frame housing member when the retractable drawer is advanced to the closed position.

Clause 6A. The fairing assembly of Clause 1A, further comprising one or more bias members, connected at one end to the retractable and an opposite end to the lower frame housing member, and operable to advance the retractable drawer between the closed position and the open position.

Clause 7A. The fairing assembly of Clause 1A, wherein an exterior surface of an upper wall of the upper frame housing member includes one or more load-bearing exterior structural rib members to bear loads applied to the fairing body.

Clause 8A. A fairing assembly, comprising: a fairing body; and a storage compartment structurally integrated with the fairing body, the storage compartment including: a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body; and a retractable drawer defining a storage space sized to receive one or more items therein, the retractable drawer being mounted in the interior space for movement in a longitudinal direction relative to the frame housing between a closed position and an open position.

Clause 9A. The fairing assembly of Clause 8A, wherein the retractable drawer comprises sidewalls having a gear track extending in a longitudinal direction along an outer surface thereof to facilitate movement of the retractable drawer between the closed position and the open position.

Clause 10A. The fairing assembly of Clause 9A, further comprising one or more rotational gear dampers, mounted on an inner surface of sidewalls of the upper frame housing member, and operatively connected to the gear track for rotation to provide resistance against the movement of the retractable drawer member between the closed position and the open position.

Clause 11A. The fairing assembly of Clause 8A, further comprising a latch member attached to the retractable drawer and moveable by engagement of a user between a latched position to initiate movement of the retractable drawer from the closed position to the open position.

Clause 12A. The fairing assembly of Clause 8A, further comprising one or more bumper members, mounted on a rear wall of the retractable drawer, and operable to engage a rear wall of the upper frame housing member when the retractable drawer is advanced to the closed position.

Clause 13A. The fairing assembly of Clause 8A, further comprising one or more bias members, connected at one end to the retractable and an opposite end to the lower frame housing member, and operable to advance the retractable drawer between the closed position and the open position.

Clause 14A. A motorcycle, comprising: a vehicle structure; and a fairing assembly connected to the vehicle structure, the fairing assembly including: a fairing body; and a storage compartment structurally integrated with the fairing body, the storage compartment including a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body, and a retractable drawer defining a storage space sized to receive one or more items therein, the retractable drawer being mounted in the interior space for movement in a longitudinal direction relative to the frame housing between a closed position and an open position.

Clause 15A. The motorcycle of Clause 14A, wherein the retractable drawer comprises sidewalls having a gear track extending in a longitudinal direction along an outer surface thereof to facilitate movement of the retractable drawer between the closed position and the open position.

Clause 16A. The fairing assembly of Clause 15A, further comprising one or more rotational gear dampers, mounted on an inner surface of sidewalls of the upper frame housing member, and operatively connected to the gear track for rotation to provide resistance against the movement of the retractable drawer member between the closed position and the open position.

Clause 17A. The motorcycle of Clause 14A, further comprising a latch member attached to the retractable drawer and moveable by engagement of a user between a latched position to initiate movement of the retractable drawer from the closed position to the open position.

Clause 18A. The motorcycle of Clause 14A, further comprising one or more bumper members, mounted on a rear wall of the retractable drawer, and operable to engage a rear wall of the upper frame housing member when the retractable drawer is advanced to the closed position.

Clause 19A. The motorcycle of claim 14, further comprising one or more bias members, connected at one end to the retractable and an opposite end to the lower frame housing member, and operable to advance the retractable drawer between the closed position and the open position.

Clause 20A. The motorcycle of Clause 14A, wherein a rear wall of the retractable drawer comprises a through hole to receive a charging cable to facilitate recharging of a rechargeable power source of an electronic device received in the storage space.

The terms “coupled,” “attached,” “mounted,” or “connected” may be used herein to refer to any type of relationship, direct or indirect, between the components in question, and may apply to electrical, mechanical, fluid, optical, electromagnetic, electro-mechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments of the present disclosure may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A fairing assembly, comprising:
a fairing body; and
a storage compartment attached to the fairing body, the storage compartment including:
a frame housing serving as a load-bearing structural member of the fairing body, the frame housing including an upper frame housing member and a lower frame housing member that collectively define an interior space; and
a retractable drawer defining a storage space sized to receive one or more items therein, the retractable drawer being mounted in the interior space for movement in a longitudinal direction relative to the frame housing between a closed position and an open position.

2. The fairing assembly of claim 1, wherein the retractable drawer comprises sidewalls having a gear track extending in a longitudinal direction along an outer surface thereof to facilitate movement of the retractable drawer between the closed position and the open position.

3. The fairing assembly of claim 2, further comprising one or more rotational gear dampers, mounted on an inner surface of sidewalls of the upper frame housing member, and operatively connected to the gear track for rotation to provide resistance against the movement of the retractable drawer member between the closed position and the open position.

4. The fairing assembly of claim 1, further comprising a latch member attached to the retractable drawer and moveable by engagement of a user between a latched position to initiate movement of the retractable drawer from the closed position to the open position.

5. The fairing assembly of claim 1, further comprising one or more bumper members, mounted on a rear wall of the retractable drawer, and operable to engage a rear wall of the upper frame housing member when the retractable drawer is advanced to the closed position.

6. The fairing assembly of claim 1, further comprising one or more bias members, connected at one end to the retractable and an opposite end to the lower frame housing member, and operable to advance the retractable drawer between the closed position and the open position.

7. The fairing assembly of claim 1, wherein an exterior surface of an upper wall of the upper frame housing member includes one or more load-bearing exterior structural rib members to bear loads applied to the fairing body.

8. A fairing assembly, comprising:
a fairing body; and
a storage compartment structurally integrated with the fairing body, the storage compartment including:
a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body; and
a retractable drawer defining a storage space sized to receive one or more items therein, the retractable drawer being mounted in the interior space for movement in a longitudinal direction relative to the frame housing between a closed position and an open position.

9. The fairing assembly of claim 8, wherein the retractable drawer comprises sidewalls having a gear track extending in a longitudinal direction along an outer surface thereof to facilitate movement of the retractable drawer between the closed position and the open position.

10. The fairing assembly of claim 9, further comprising one or more rotational gear dampers, mounted on an inner surface of sidewalls of the upper frame housing member, and operatively connected to the gear track for rotation to provide resistance against the movement of the retractable drawer member between the closed position and the open position.

11. The fairing assembly of claim 8, further comprising a latch member attached to the retractable drawer and moveable by engagement of a user between a latched position to initiate movement of the retractable drawer from the closed position to the open position.

12. The fairing assembly of claim 8, further comprising one or more bumper members, mounted on a rear wall of the retractable drawer, and operable to engage a rear wall of the upper frame housing member when the retractable drawer is advanced to the closed position.

13. The fairing assembly of claim 8, further comprising one or more bias members, connected at one end to the retractable and an opposite end to the lower frame housing member, and operable to advance the retractable drawer between the closed position and the open position.

14. A vehicle, comprising:
a vehicle structure; and
a fairing assembly connected to the vehicle structure, the fairing assembly including:
a fairing body; and
a storage compartment structurally integrated with the fairing body, the storage compartment including a frame housing serving as a load-bearing structural member of the fairing body, the frame housing including an upper frame housing member and a lower frame housing member that collectively define an interior space, the upper frame housing member having an upper wall with an exterior surface that includes one or more load-bearing exterior structural rib members to bear loads applied to the fairing body, and a retractable drawer defining a storage space sized to receive one or more items therein, the retractable drawer being mounted in the interior space for movement in a longitudinal direction relative to the frame housing between a closed position and an open position.

15. The vehicle of claim 14, wherein the retractable drawer comprises sidewalls having a gear track extending in a longitudinal direction along an outer surface thereof to facilitate movement of the retractable drawer between the closed position and the open position.

16. The vehicle of claim 15, further comprising one or more rotational gear dampers, mounted on an inner surface of sidewalls of the upper frame housing member, and operatively connected to the gear track for rotation to provide resistance against the movement of the retractable drawer member between the closed position and the open position.

17. The vehicle of claim 14, further comprising a latch member attached to the retractable drawer and moveable by engagement of a user between a latched position to initiate movement of the retractable drawer from the closed position to the open position.

18. The vehicle of claim 14, further comprising one or more bumper members, mounted on a rear wall of the retractable drawer, and operable to engage a rear wall of the upper frame housing member when the retractable drawer is advanced to the closed position.

19. The vehicle of claim 14, further comprising one or more bias members, connected at one end to the retractable and an opposite end to the lower frame housing member, and operable to advance the retractable drawer between the closed position and the open position.

20. The vehicle of claim 14, wherein a rear wall of the retractable drawer comprises a through hole to receive a charging cable to facilitate recharging of a rechargeable power source of an electronic device received in the storage space.
